(19) United States
(12) Patent Application Publication
(10) Pub. No.: US 2025/0293583 A1
(43) Pub. Date: Sep. 18, 2025

(54) POWER SUPPLY

(71) Applicant: Chicony Power Technology Co., Ltd., New Taipei City (TW)

(72) Inventors: Min-Han LEE, New Taipei City (TW); Meng-Yuan TSAI, New Taipei City (TW)

(21) Appl. No.: 18/663,107

(22) Filed: May 14, 2024

(30) Foreign Application Priority Data
Mar. 14, 2024 (TW) 113109514

(51) Int. Cl. H02M 1/00; H02M 7/217

(52) U.S. Cl. CPC H02M 1/0067; H02M 7/217

(57) ABSTRACT

The present disclosure provides a power supply including first auxiliary winding, a second auxiliary winding, a first supply circuit and a second supply circuit. The first supply circuit includes a first rectifier circuit and a first regulator circuit. The second supply circuit includes a second rectifier circuit and a second regulator circuit. The first auxiliary winding and the second auxiliary winding supply to a primary side controller through the first rectifier circuit and the first regulator circuit of the first supply circuit; or the first auxiliary winding supply to the primary side controller through the second rectifier circuit and the second regulator circuit of the second supply circuit.

### RELATED APPLICATIONS

This application claims priority to Taiwan Application Serial Number 113109514, filed Mar. 14, 2024, which is herein incorporated by reference.

### BACKGROUND

### Field of Invention

The disclosure relates to a power supply. More particularly, the disclosure relates to a power supply capable for supplying power to a primary side controller within a wide output voltage range.

### Description of Related Art

As the performance of electronic products continues to improve, the demands for the battery capacity of the electronic device and the power of the adapter are gradually increased. To expand the maximum output power of the adapter, the universal serial bus implementers forum proposed a power delivery specification revision 3.1 in 2021. Compare to the power delivery revision 3.0 specification including the output voltage range between 5 volts and 20 volts, three new output voltages of 28 volts, 36 volts and 48 volts are added into the power delivery revision 3.1 specification. The aforesaid output voltage is proportional to a voltage across the auxiliary winding which is commonly used to power to the primary side controller, it means that a difference between the maximum voltage (e.g., 48 volts) across the auxiliary winding and the minimum voltage (e.g., 5 volts) across the auxiliary winding is 9.6 times, it is far more than the magnification range of supply voltage for the general primary side controller.

To meet the requirement of the supply voltage range for the primary side controller in a wide output voltage range, two auxiliary windings cooperated with a single voltage regulator circuit have been traditionally used to supply power to the primary side controller. In this structure, the number of turns (e.g., 2 turns) of one auxiliary winding of two the auxiliary windings required to be small enough, so as to provide the supply voltage (e.g., 23.1 volts) through the said auxiliary winding to the primary side controller when the output voltage is 48 volts. On the other hand, the total turns (e.g., 11 turns) of the two the auxiliary winding required to be large enough to provide the supply voltage (e.g., 18.4 volts) through the two auxiliary windings and the voltage regulator circuit to the primary side controller when the output voltage is within a range of 5 volts to 36 volts. In these cases, since the total turns of the two auxiliary winding are large enough, the peak voltage across the two auxiliary winding is much higher under the condition of the higher output voltage, it causes that a voltage across the voltage regulator circuit is quite large, leading to the great consumption during the supply current flowing through the voltage regulator circuit. For example, if the output voltage is 28 volts, the peak voltage across the two auxiliary windings is 91 volts, the supply voltage that the two auxiliary windings provide through the voltage regulator circuit to the controller is 18.4 volts, a voltage drop across the voltage regulator circuit is 71.7 volts, leading to a consumption of 0.717 W during a 10 mA supply current flowing through the voltage regulator circuit. For the other example, if the output voltage is 36 volts, the peak voltage across the two auxiliary windings is 117 volts, the supply voltage that the two auxiliary windings provide through the voltage regulator circuit to the controller is 18.4 volts, a voltage drop across the voltage regulator circuit is 97.7 volts, leading to a consumption of 0.977 W during a 10 mA supply current flowing through the voltage regulator circuit.

Therefore, how to provide an auxiliary winding circuit to solve the above problems is an important issue in this filed.

### SUMMARY

The present disclosure provides a power supply. The power supply includes a first auxiliary winding, a second auxiliary winding, a first supply circuit, and a second supply circuit. A first end of the first auxiliary winding is electrically connected to a ground terminal. A first end of the second auxiliary winding is electrically connected to a second end of the first auxiliary winding. The first supply circuit is electrically connected between a second end of the second auxiliary winding and a primary side controller. The first supply circuit includes a first rectifier circuit and a first voltage regulator circuit. The second supply circuit is electrically connected between the second end of the first auxiliary winding and the primary side controller. The second supply circuit includes a second rectifier circuit and a second voltage regulator circuit. The first auxiliary winding and the second auxiliary winding power to the primary side controller through the first rectifier circuit and the first voltage regulator circuit of the first supply circuit; or the first auxiliary winding power to the primary side controller through the second rectifier circuit and the second voltage regulator circuit of the second supply circuit.

Summary, the power supply power to the controller by two auxiliary windings cooperated with two voltage regulator circuits, which is able to expand an operating voltage range for supplying power to the controller by the second auxiliary winding and the second voltage regulator circuit, and accordingly reduce an operating voltage range for supplying power to the controller by the first auxiliary winding and the first voltage regulator circuit, in order to reduce and disperse overall loss, and further to lower the specification for selecting components.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure.

FIG. 1 depicts a schematic diagram of power supply according to some embodiments of the present disclosure.

FIG. 2 depicts a schematic diagram of a voltage regulator circuit according to some embodiments of the present disclosure.

FIG. 3 depicts a schematic diagram of a power supply according to some embodiments of the present disclosure.

FIG. 4A depicts a schematic diagram of an operation of an auxiliary winding circuit during the output voltage of the power supply being at voltage Vₒᵤₜₐ.

FIG. 4B depicts a schematic diagram of an operation of the auxiliary winding circuit during the output voltage of the power supply being at voltage V_{outb}.

FIG. 4C depicts a schematic diagram of an operation of the auxiliary winding circuit during the output voltage of the power supply being at voltage V_{outc}.

FIG. 4D depicts a schematic diagram of an operation of an auxiliary winding circuit during the output voltage of the power supply being at voltage V_{outd}.

FIG. 5 depicts a schematic diagram of power supply according to some embodiments of the present disclosure.

FIG. 6 depicts a schematic diagram of power supply according to some embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. Description of the operation does not intend to limit the operation sequence. Any structures resulting from recombination of elements with equivalent effects are within the scope of the present disclosure. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

In the description herein and throughout the claims that follow, unless otherwise defined, all terms have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In the description herein and throughout the claims that follow, the terms “comprise” or “comprising,” “include” or “including,” “have” or “having,” “contain” or “containing” and the like used herein are to be understood to be open-ended, i.e., to mean including but not limited to.

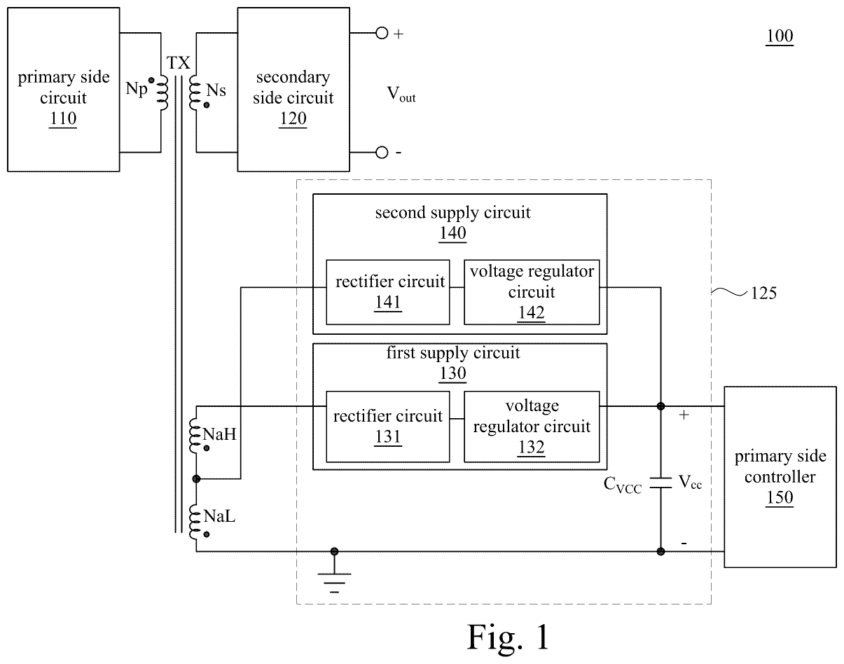

A description is provided with reference to FIG. 1. FIG. 1 depicts a schematic diagram of power supply 100 according to some embodiments of the present disclosure. As shown in FIG. 1, the power supply 100 includes a primary side circuit 110, a secondary side circuit 120, a transformer TX, an auxiliary winding circuit 125 and a primary side controller 150. In some embodiments, the transformer TX includes a primary side winding Np, a secondary side winding Ns and auxiliary windings NaH and NaL. In some embodiments, the primary side controller 150 is configured to control the power switch included in the primary side circuit 110 to turn on or turn off, to release energy from or store energy in the primary side winding Np, and the energy can be transferred to the secondary side winding Ns, such that the output voltage Vₒᵤₜ is generated through the secondary side winding Ns and the secondary side circuit 120. In some embodiments, the auxiliary windings NaH and NaL generates the input voltage, by inductive coupling, to the auxiliary winding circuit 125. In some embodiments, the secondary side winding Ns and the auxiliary windings NaH and NaL are inductively coupled to the primary side winding Np. In some embodiments, the current flowing through the primary side winding Np induces a voltage across the secondary side winding Ns, a voltage across the auxiliary winding NaH and a voltage across the auxiliary windings NaH and NaL, In some embodiments, the secondary side circuit 120 rectifies the induced voltage across the secondary side winding Ns to generate the output voltage Vₒᵤₜ, and the output voltage Vₒᵤₜ is proportional to a voltage across the auxiliary winding NaH and a voltage across the auxiliary windings NaH and NaL.

In some embodiments, the auxiliary winding circuit 125 includes a first supply circuit 130, a second supply circuit 140 and a capacitor C_{VCC}. In some embodiments, the auxiliary windings NaH and NaL provide the supply voltage V_{CC} to the primary side controller 150 through the first supply circuit 130 of the auxiliary winding circuit 125; or the auxiliary winding NaL provides the supply voltage V_{CC} to the primary side controller 150 through the second supply circuit 140 of the auxiliary winding circuit 125.

In structure, the auxiliary windings NaH and NaL and the first supply circuit 130 are electrically connected in series between the ground terminal and a power end of the primary side controller. The auxiliary winding NaL and the second supply circuit 140 are electrically connected in series between the ground terminal and the power end of the primary side controller. Specifically, a first end of the auxiliary winding NaL is electrically connected to the ground terminal, and a second end of the auxiliary winding NaL is electrically connected to a first end of the auxiliary winding NaH. The first supply circuit 130 is electrically connected between a second end of the auxiliary winding NaH and the power end of the primary side controller. The second supply circuit 140 is electrically connected between the second end of the auxiliary winding NaL and the power end of the primary side controller.

In some embodiments, the first supply circuit 130 includes a rectifier circuit 131 and a voltage regulator circuit 132. In some embodiments, the rectifier circuit 131 and the voltage regulator circuit 132 are electrically connected in series between the second end of the auxiliary winding NaH and the power end of the primary side controller. In some embodiments, the second supply circuit 140 includes a rectifier circuit 141 and a rectifier circuit 141. In some embodiments, the rectifier circuit 141 and the voltage regulator circuit 142 are electrically connected in series between the second end of auxiliary winding NaL and the power end of the primary side controller.

In some embodiments, when the output voltage Vₒᵤₜ is less than a predetermined voltage, the power supply 100 power to the primary side controller 150 through the auxiliary windings NaH and NaL and the rectifier circuit 131 and the voltage regulator circuit 132 included in the first supply circuit 130. In some embodiments, when the output voltage Vₒᵤₜ is greater than the predetermined voltage, the power supply 100 power to the primary side controller 150 through the auxiliary winding NaL and the rectifier circuit 141 and the voltage regulator circuit 142 included in the second supply circuit 140.

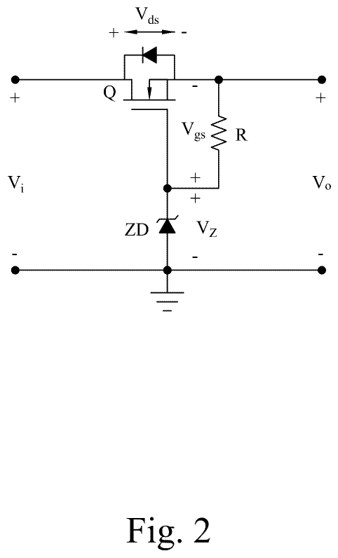

A description is provided with reference to FIG. 2. FIG. 2 depicts a schematic diagram of a voltage regulator circuit according to some embodiments of the present disclosure. In some embodiments, the circuit structure of each of the voltage regulator circuits 132 and 142 in FIG. 1 corresponds to the structure of the voltage regulator circuit in FIG. 2. In some embodiments, the voltage regulator circuit includes a regulator diode ZD, a regulator switch and a resistor R. In some embodiments, a first end of the regulator diode ZD is configured to receive an input voltage Vᵢ, and a second end of the regulator diode ZD is configured to provide the voltage Vₒ. In some embodiments, a control end of the regulator switch Q is electrically connected to the first end of the regulator diode ZD, and a second end of the regulator diode ZD is electrically connected to the ground terminal. In some embodiments, if the voltage at the control end of the regulator switch Q is less than a clamp voltage of the regulator diode ZD, the regulator diode ZD is in an off-state, such that the voltage Vₒ at the second end of the regulator switch Q is substantially equal to a difference between a voltage at the control end of the regulator switch Q and the voltage V_{gs}. Meanwhile, the voltage V_{z} across the regulator diode ZD is less than the clamp voltage of the regulator diode ZD. In some embodiments, since the regulator switch Q is cut off when the voltage across the gate and source of the regulator switch Q is equal to a threshold voltage, the voltage Vₒ at the second end the regulator switch Q is substantially equal to a difference between the voltage at the control end of the regulator switch Q and a threshold voltage of the regulator switch Q.

In some embodiments, if the voltage at the regulator switch Q is greater than the clamp voltage of the regulator diode ZD, the regulator diode ZD is in an on-state, such that the voltage Vₒ at the second end of the regulator switch Q is substantially equal to a difference between a clamp voltage of the regulator diode ZD and the voltage V_{gs}. Meanwhile, the voltage V_{z} across the regulator diode ZD is equal to the clamp voltage of the regulator diode ZD. In some embodiments, since the regulator switch Q is cut off when the voltage across the gate and source of the regulator switch Q is equal to a threshold voltage, the voltage Vₒ at the second end the regulator switch Q is substantially equal to the difference between the clamp voltage of the regulator diode ZD and the threshold voltage of the regulator switch Q.

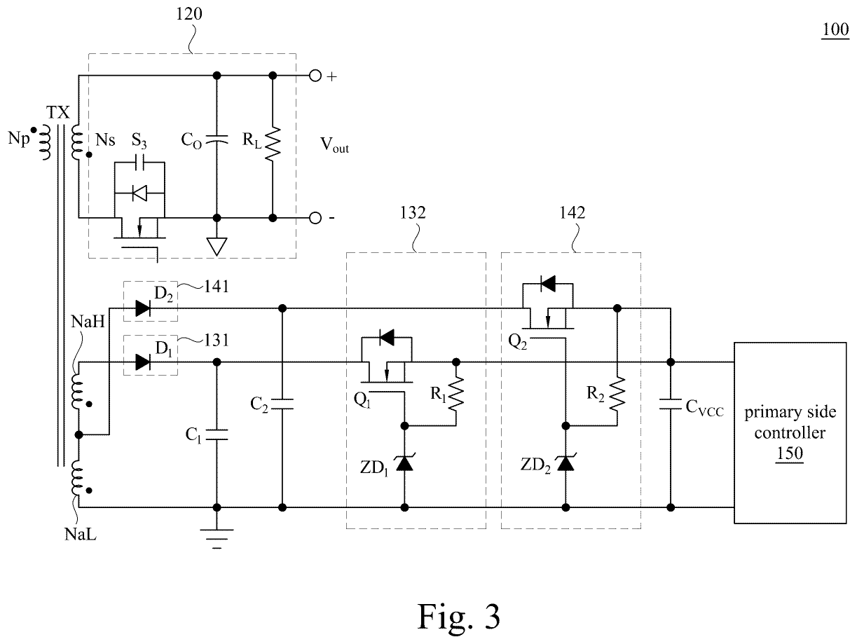

A description is provided with reference to FIG. 3. FIG. 3 depicts a schematic diagram of a power supply 100 according to some embodiments of the present disclosure. In some embodiments, the secondary side circuit 120 includes a switch S₃, an output capacitor C_{O} and a load R_{L}. In some embodiments, the switch S₃ has low on-resistance, configured to rectifier the output of the secondary side circuit 120. In some embodiments, the rectifier circuit 131 includes a diode D₁.

In some embodiments, a first end of the diode D₁ is electrically connected to the second end of the auxiliary winding NaH, and a second end of the diode D₁ is electrically connected to the voltage regulator circuit 132. In some embodiments, the diode D₁ is configured to rectifier the voltage generated by the auxiliary windings NaL and NaH by inductive coupling. In some embodiments, the voltage drop across the rectifier circuit 131 is 0.9 volts. In some embodiments, the voltage drop across the diode D₁ is 0.9 volts.

In some embodiments, a first end of the diode D₂ is electrically connected to the second end of the auxiliary winding NaL, and a second end of the diode D₂ is electrically connected to the voltage regulator circuit 142. In some embodiments, the diode D₂ is configured to rectifier the voltage generated by the auxiliary winding NaL by inductive coupling. In some embodiments, a voltage drop across the rectifier circuit 141 is 0.9 volts. In some embodiments, a voltage drop across the diode D₂ is 0.9 volts.

In some embodiments, the power supply 100 further includes smoothing capacitors C₁ and C₂. In some embodiments, the smoothing capacitor C₁ is electrically connected between and output end of the rectifier circuit 131 and the ground terminal, and the smoothing capacitor C₁ is configured to smooth the rectified voltage output by the rectifier circuit 131. In some embodiments, the smoothing capacitor C₂ is electrically connected between the output end of the rectifier circuit 141 and the ground terminal, and the smoothing capacitor C₂ is configured to smooth the rectified voltage output by the rectifier circuit 141.

In some embodiments, the voltage regulator circuit 132 includes a regulator switch Q₁, regulator diode ZD₁ and a resistor R₁. In some embodiments, the clamp voltage of the regulator diode ZD₁ is 17 volts. In some embodiments, the threshold voltage of the regulator switch Q₁ is −1.4 volts. In some embodiments, the connection relationship and the operation manner of the regulator switch Q₁, the regulator diode ZD₁ and the resistor R₁ included in the voltage regulator circuit 132 are the same/similar with the regulator switch Q, the regulator diode ZD and the resistor R included in the voltage regulator circuit in FIG. 2, and the description is omitted here.

In some embodiments, the voltage regulator circuit 142 includes a regulator switch Q₂, regulator diode ZD₂ and a resistor R₂. In some embodiments, the clamp voltage of the regulator diode ZD₂ is greater than the clamp voltage of the regulator diode ZD₁. In some embodiments, the clamp voltage of the regulator diode ZD₂ is 19 volts. In some embodiments, the threshold voltage of the regulator switch Q₂ is −1.4 volts. In some embodiments, the connection relationship and the operation manner of the regulator switch Q₂, the regulator diode ZD₂ and the resistor R₂ included in the voltage regulator circuit 142 are the same as or similar with the regulator switch Q, the regulator diode ZD and the resistor R included in the voltage regulator circuit in FIG. 2, and the description is omitted here.

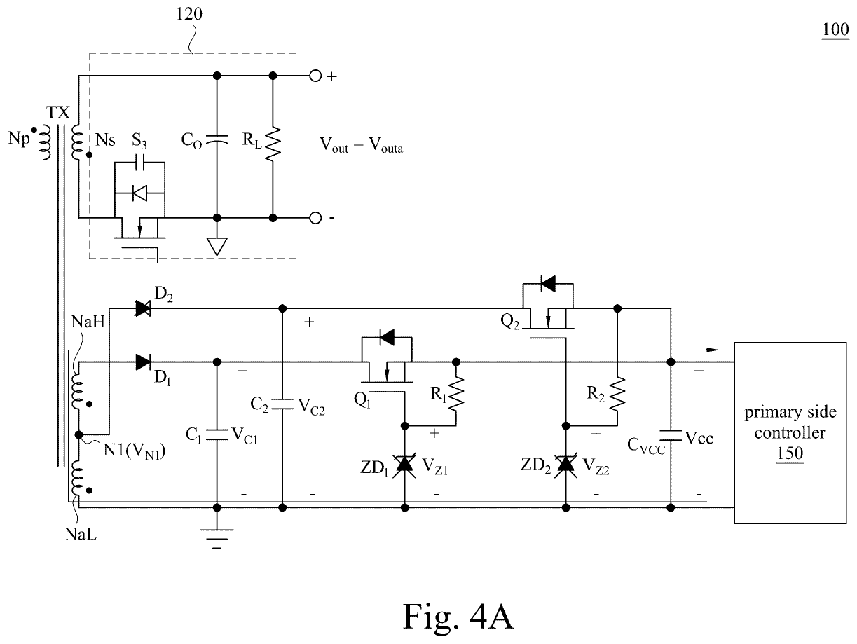

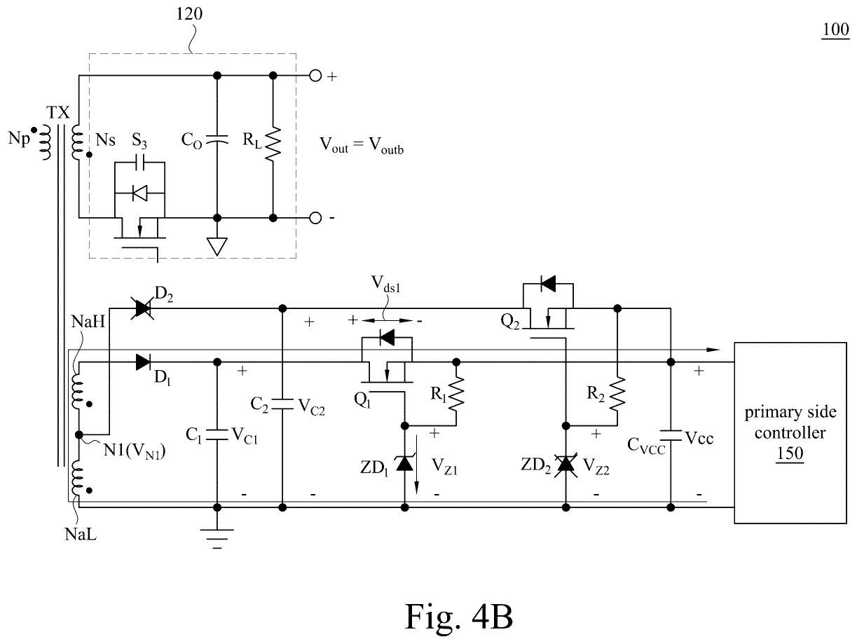

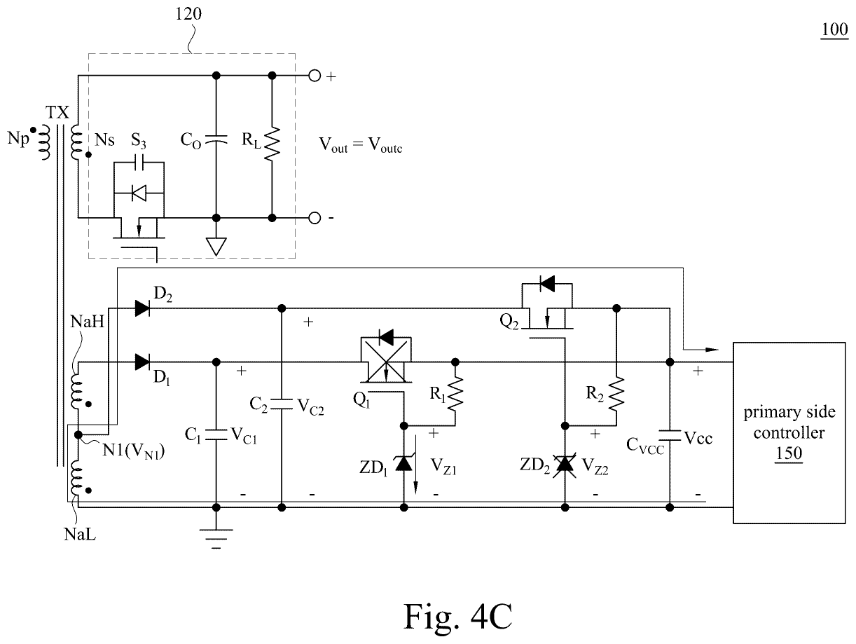

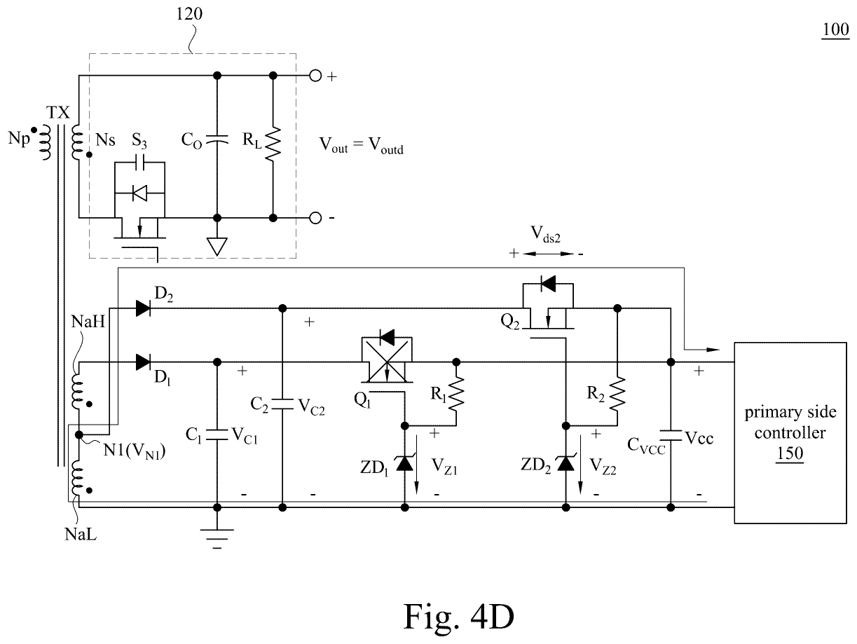

A description is provided with reference to FIG. 1 to FIG. 4A. FIG. 4A depicts a schematic diagram of an operation of an auxiliary winding circuit 125 during the output voltage of the power supply being at voltage Vₒᵤₜₐ. In some embodiments, the voltage Vₒᵤₜₐ is less than a predetermined value (e.g., 20 volts). In some embodiments, the voltage Vₒᵤₜₐ is 5 volts.

In some embodiments, the number of turns of the auxiliary winding NaH is more than the number of turns of the auxiliary winding NaL. In some embodiments, a turn ratio of the auxiliary winding NaH to the auxiliary winding NaL is less than 5. In some embodiments, a turn ratio of the auxiliary winding NaH to the auxiliary winding NaL is less than 3. In some embodiments, a turn ratio of the auxiliary winding NaH to the auxiliary winding NaL is equal to 2.25. In some embodiments, the number of turns of the auxiliary winding NaH is 9, and the number of turns of the auxiliary winding NaL is 4. The following embodiments will be described under the conditions of 9 turns of the auxiliary winding NaH and 4 turns of the auxiliary winding NaL. In some embodiments, if the output voltage Vₒᵤₜ is 5 volts, the peak voltage of the input voltage (such as, a voltage V_{N1} at node N1) generated by the auxiliary winding NaL by inductive coupling is 5 volts, and a peak voltage of the input voltage generated by the auxiliary windings NaL and NaH by inductive coupling is 16.3 volts.

In theory, when a voltage at the first end of the smoothing capacitor C₂, which can be derived from subtracting the voltage drop (e.g., 0.9 volts) of the diode D₂ from the peak voltage (e.g., 5 volts) of the input voltage across the auxiliary winding NaL, is 4.1 volts, the regulator diode ZD₂ is in the off-state to not clamp the voltage because the voltage of 4.1 volts is less than a difference (e.g., 20.4 volts) between the clamp voltage (e.g., 19 volts) of the regulator diode ZD₂ and the threshold voltage (e.g., −1.4 volts) of the regulator switch Q₂, as such the output of the second supply circuit 140 is 4.1 volts. When a voltage at the first end of the smoothing capacitor C₁, which can be derived from subtracting the voltage drop (e.g., 0.9 volts) of the diode D₁ from the peak voltage (e.g., 16.3 volts) of the input voltage across the auxiliary windings NaL and NaH, is 15.4 volts, the regulator diode Z_{D1} is in the off-state to not clamp the voltage because the voltage of 15.4 volts is less than a difference (e.g., 18.4 volts) between the clamp voltage (e.g., 17 volts) of the regulator diode ZD₁ and the threshold voltage (e.g., −1.4 volts) of the regulator switch Q₁, as such the output of the first supply circuit 130 is 15.4 volts.

In some embodiments, when the output voltage Vₒᵤₜ is equal to 5 volts, since the supply voltage output by the first supply circuit 130 is greater than the supply voltage output by the second supply circuit 140, the primary side controller 150 is powered by the first supply circuit 130 (such as, the supply voltage V_{CC} is 15.4 volts), and the diode D₂ included in the second supply circuit 140 is turned off due to the reverse bias. In some embodiments, since the supply voltage output by the first supply circuit 130 is transmitted through the regulator switch Q₂ to the second end of the diode D₂, the diode D₂ included in the second supply circuit 140 is turned off due to the reverse bias.

In some embodiments, the number of turns of the auxiliary winding NaH is more than the number of turns of the auxiliary winding NaL. In some embodiments, a turn ratio of the auxiliary winding NaH to the auxiliary winding NaL is less than 5. In some embodiments, a turn ratio of the auxiliary winding NaH to the auxiliary winding NaL is less than 3. In some embodiments, a turn ratio of the auxiliary winding NaH to the auxiliary winding NaL is equal to 2.25. In some embodiments, the number of turns of the auxiliary winding NaH is 9, and the number of turns of the auxiliary winding NaL is 4. The following embodiments will be described under the conditions of 9 turns of the auxiliary winding NaH and 4 turns of the auxiliary winding NaL.

A description is provided with reference to FIG. 1 to FIG. 4B. FIG. 4B depicts a schematic diagram of an operation of the auxiliary winding circuit 125 during the output voltage of the power supply being at voltage V_{outb}. In some embodiments, the voltage V_{outb} is less than the predetermined value (e.g., 20 volts). In some embodiments, the voltage V_{outb} is 9 volts or 15 volts.

In some embodiments, if the output voltage Vₒᵤₜ is 9 volts, the peak voltage of the input voltage (such as, a voltage V_{N1} at node N1) generated by the auxiliary winding NaL by inductive coupling is 9 volts, and a peak voltage of the input voltage generated by the auxiliary windings NaL and NaH by inductive coupling is 29.3 volts.

In theory, when a voltage at the first end of the smoothing capacitor C₂, which can be derived from subtracting the peak voltage (e.g., 9 volts) of the voltage drop (e.g., 0.9 volts) of the diode D₂ from the input voltage across the auxiliary winding NaL, is 8.1 volts, the regulator diode ZD₂ is in the off-state to not clamp the voltage because the voltage of 8.1 volts is less than a difference (e.g., 20.4 volts) between the clamp voltage (e.g., 19 volts) of the regulator diode ZD₂ and the threshold voltage (e.g., −1.4 volts) of the regulator switch Q₂, as such the output of the second supply circuit 140 is 8.1 volts. On the other hand, when a voltage at the first end of the smoothing capacitor C₁, which can be derived from subtracting the voltage drop (e.g., 0.9 volts) of the diode D₁ from the peak voltage (e.g., 29.3 volts) of the input voltage across the auxiliary windings NaL and NaH, is 28.4 volts, the regulator diode Z_{D1} is in the on-state to clamp the voltage because the voltage of 28.4 volts is greater than a difference (e.g., 18.4 volts) between the clamp voltage (e.g., 17 volts) of the regulator diode Z_{D1} and the threshold voltage (e.g., −1.4 volts) of the regulator switch Q₁, as such the output of the first supply circuit 130 is 18.4 volts (a difference the clamp voltage of the regulator diode Z_{D1} and the threshold voltage of the regulator switch Q₁). In other word, when the peak voltage (e.g., 29.3 volts) of the input voltage generated by the auxiliary windings NaL and NaH by inductive coupling exceeds a sum of the clamp voltage (e.g., 17 volts) of the regulator diode ZD₁, an negative of a threshold voltage (e.g., −1.4 volts) of the regulator switch Q₁ and a voltage drop (e.g., 0.9 volts) of the rectifier circuit 131, the voltage regulator circuit 132 is configured to clamp the said input voltage to a first voltage (e.g., the voltage of 18.4 volts).

In some embodiments, when the output voltage Vₒᵤₜ is equal to 9 volts, since the supply voltage output by the first supply circuit 130 is greater than the supply voltage output by the second supply circuit 140, the primary side controller 150 is powered by the first supply circuit 130 (such as, the supply voltage V_{CC} is 18.4 volts), and the diode D₂ included in the second supply circuit 140 is turned off due to the reverse bias. In some embodiments, since the supply voltage output by the first supply circuit 130 is transmitted through the regulator switch Q₂ to the second end of the diode D₂, the diode D₂ included in the second supply circuit 140 is turned off due to the reverse bias.

In some embodiments, when the output voltage Vₒᵤₜ is equal to V_{outb}, voltages at some nodes of the power supply 100 can be expressed by the Table 1 as follow.

TABLE 1

| | | |
|---|---|---|
| V_{outb} (V) | 9 | 15 |
| V_{C1} (V) | 28.4 | 47.9 |
| V_{C2} (V) | 18.4 | 18.4 |
| V_{CC} (V) | 18.4 | 18.4 |
| V_{ds1} | 10 | 29.5 |

As shown in the above Table 1, when the output voltage Vₒᵤₜ is equal to V_{outb}, the voltage Vast across drain and source of the regulator switch Q₁ is quite small, if the supply current is 10 mA, the consumptions of the voltage regulator circuit 132 are 0.010 W and 0.295 W under the conditions of the output voltage Vₒᵤₜ being at 9 volts and 15 volts, respectively, and the overall loss can be reduced.

A description is provided with reference to FIG. 1 to FIG. 4C. FIG. 4C depicts a schematic diagram of an operation of the auxiliary winding circuit 125 during the output voltage of the power supply being at voltage V_{outc}. In some embodiments, the voltage V_{outc} is not less than the predetermined value (e.g., 20 volts). In some embodiments, the voltage V_{outc} is 20 volts.

In some embodiments, if the output voltage Vₒᵤₜ is 20 volts, the peak voltage of the input voltage (such as, a voltage V_{N1} at node N1) generated by the auxiliary winding NaL by inductive coupling is 20 volts, and a peak voltage of the input voltage generated by the auxiliary windings NaL and NaH by inductive coupling is 65 volts.

In theory, when a voltage at the first end of the smoothing capacitor C₂, which can be derived from subtracting the voltage drop (e.g., 0.9 volts) of the diode D₂ from the peak voltage (e.g., 20 volts) of the input voltage across the auxiliary winding NaL, is 19.1 volts, the regulator diode ZD₂ is in an off-state to not clamp the voltage because the voltage of 19.1 volts is less than a difference (e.g., 20.4 volts) between the clamp voltage (e.g., 19 volts) of the regulator diode ZD₂ and the threshold voltage (e.g., −1.4 volts) of the regulator switch Q₂, as such the output of the second supply circuit 140 is 19.1 volts. On the other hand, when a voltage at the first end of the smoothing capacitor C₁, which can be derived from subtracting the voltage drop (e.g., 0.9 volts) of the diode D₁ from the peak voltage (e.g., 65 volts) of the input voltage across the auxiliary windings NaL and NaH, is 64.1 volts, the regulator diode Z_{D1} is in the on-state to clamp the voltage because the voltage of 64.1 volts is greater than a difference (e.g., 18.4 volts) between the clamp voltage (e.g., 17 volts) of the regulator diode Z_{D1} and the threshold voltage (e.g., −1.4 volts) of the regulator switch Q₁, as such the output of the first supply circuit 130 is 18.4 volts (a difference the clamp voltage of the regulator diode Z_{D1} and the threshold voltage of the regulator switch Q₁).

In some embodiments, when the output voltage Vₒᵤₜ is equal to 20 volts, since the supply voltage output by the first supply circuit 130 is less than the supply voltage output by the second supply circuit 140, the primary side controller 150 is powered by the second supply circuit 140 (such as, the supply voltage V_{CC} is 19.1 volts), and the regulator switch Q₁ included in the first supply circuit 130 is turned off. In some embodiments, since the supply voltage output by the second supply circuit 140 is transmitted to the second end of the regulator switch Q₁, the regulator switch Q₁ included in the first supply circuit 130 is turned off due to the voltage across the gate and source of the regulator switch Q₁ being less than the threshold voltage of the regulator switch Q₁.

A description is provided with reference to FIG. 1 to FIG. 4D. FIG. 4D depicts a schematic diagram of an operation of an auxiliary winding circuit 125 during the output voltage of the power supply being at voltage V_{outd}. In some embodiments, the voltage V_{outd} is not less than the predetermined value (e.g., 20 volts). In some embodiments, the voltage V_{outd} is 28 volts, 36 volts or 48 volts.

In some embodiments, if the output voltage Vₒᵤₜ is 28 volts, the peak voltage of the input voltage (such as, a voltage V_{N1} at node N1) generated by the auxiliary winding NaL by inductive coupling is 28 volts, and a peak voltage of the input voltage generated by the auxiliary windings NaL and NaH by inductive coupling is 91 volts.

In theory, when a voltage at the first end of the smoothing capacitor C₂, which can be derived from subtracting the voltage drop (e.g., 0.9 volts) of the diode D₂ from the peak voltage (e.g., 28 volts) of the input voltage across the auxiliary winding NaL, is 27.1 volts, the regulator diode ZD₂ is in the on-state to clamp the voltage because the voltage of 27.1 volts is greater than a difference (e.g., 20.4 volts) between the clamp voltage (e.g., 19 volts) of the regulator diode ZD₂ and the threshold voltage (e.g., −1.4 volts) of the regulator switch Q₂, as such the output of the second supply circuit 140 is 20.4 volts. In other word, when the input voltage (such as, the peak voltage thereof is 28 volts) generated by the auxiliary winding NaL by inductive coupling exceeds a sum of the clamp voltage (e.g., 19 volts) of the regulator diode ZD₂, an negative of a threshold voltage (e.g., −1.4 volts) of the regulator switch Q₂ and a voltage drop (e.g., 0.9 volts) of the rectifier circuit 141, the voltage regulator circuit 142 is configured to clamp the said input voltage to a second voltage (e.g., the voltage of 20.4 volts). In some embodiments, the second voltage (e.g., the voltage of 20.4 volts) output by performing the voltage clamping by the voltage regulator circuit 142 is greater than the first voltage (e.g., the voltage of 18.4 volts) output by performing the voltage clamping by the voltage regulator circuit 132. In addition, when a voltage at the first end of the smoothing capacitor C₁, which can be derived from subtracting the voltage drop (e.g., 0.9 volts) of the diode D₁ from the peak voltage (e.g., 91 volts) of the input voltage across the auxiliary windings NaL and NaH, is 90.1 volts, the regulator diode Z_{D1} is in the on-state to clamp the voltage because the voltage of 90.1 volts is greater than a difference (e.g., 18.4 volts) between the clamp voltage (e.g., 17 volts) of the regulator diode Z_{D1} and the threshold voltage (e.g., −1.4 volts) of the regulator switch Q₁, as such the output of the first supply circuit 130 is 18.4 volts (a difference the clamp voltage of the regulator diode Z_{D1} and the threshold voltage of the regulator switch Q₁).

In some embodiments, when the output voltage Vₒᵤₜ is equal to 28 volts, since the supply voltage output by the first supply circuit 130 is less than the supply voltage output by the second supply circuit 140, the primary side controller 150 is powered by the second supply circuit 140 (such as, the supply voltage V_{CC} is 20.4 volts), and the regulator switch Q₁ included in the first supply circuit 130 is turned off. In some embodiments, since the supply voltage output by the second supply circuit 140 is transmitted to the second end of the regulator switch Q₁, the regulator switch Q₁ included in the first supply circuit 130 is turned off due to the voltage across the gate and source of the regulator switch Q₁ being less than the threshold voltage thereof.

In some embodiments, when the output voltage Vₒᵤₜ is equal to V_{outd}, voltages at some nodes of the power supply 100 can be expressed by the Table 2 as follow.

TABLE 2

| | | | |
|---|---|---|---|
| V_{outd} (V) | 28 | 36 | 48 |
| V_{C1} (V) | 90.1 | 116.1 | 155.1 |
| V_{C2} (V) | 27.1 | 35.1 | 47.1 |
| V_{CC} (V) | 20.4 | 20.4 | 20.4 |
| V_{ds2} | 6.7 | 14.7 | 26.7 |

As shown in the above Table 2, when the output voltage Vₒᵤₜ is equal to V_{outd}, the voltage Vast across drain and source of the regulator switch Q₂ is relatively small, if the supply current is 10 mA, the consumptions of the voltage regulator circuit 142 are 0.067 W, 0.147 W and 0.267 W under the conditions of the output voltage Vₒᵤₜ being at 28 volts, 36 volts and 48 volts, respectively, and the overall loss can be reduced and dispersed within the wide output voltage range.

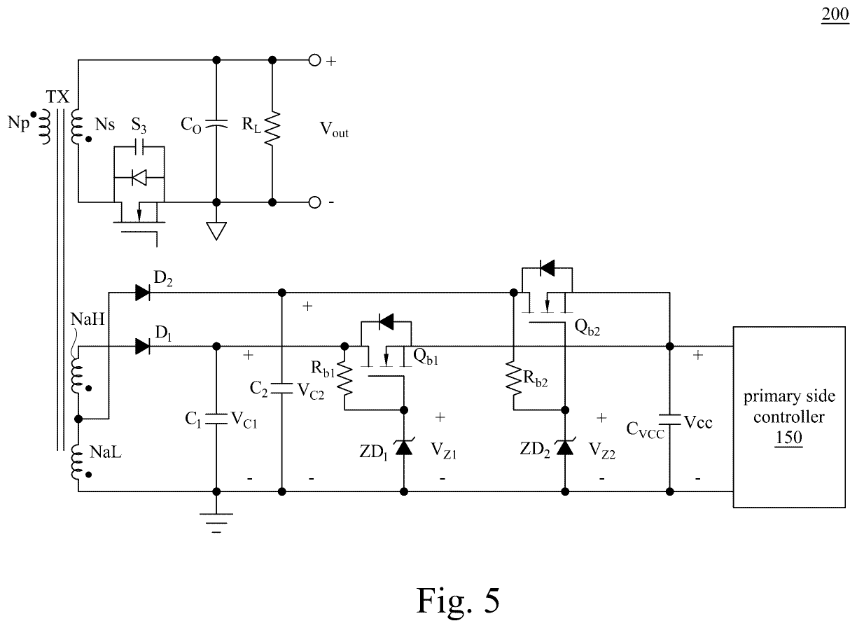

A description is provided with reference to FIG. 5. FIG. 5 depicts a schematic diagram of power supply 200 according to some embodiments of the present disclosure. Compare to FIG. 3 illustrates the power supply 100 including the regulator switches Q₁ and Q₂ implemented by the depletion field effect transistors, the regulator switches Q_{b1} and Q_{b2} included in the power supply 200 in FIG. 5 are implemented by enhanced field effect transistors, and the resistors R_{b1} and R_{b2} are disposed accordingly to achieve the same/similar functions with the power supply 100. In some embodiments, the connection relationship and operation manner of the other elements included in the power supply 200 are the same to or similar with the connection relationship and operation manner of the other elements included in the power supply 200, and the description is omitted here.

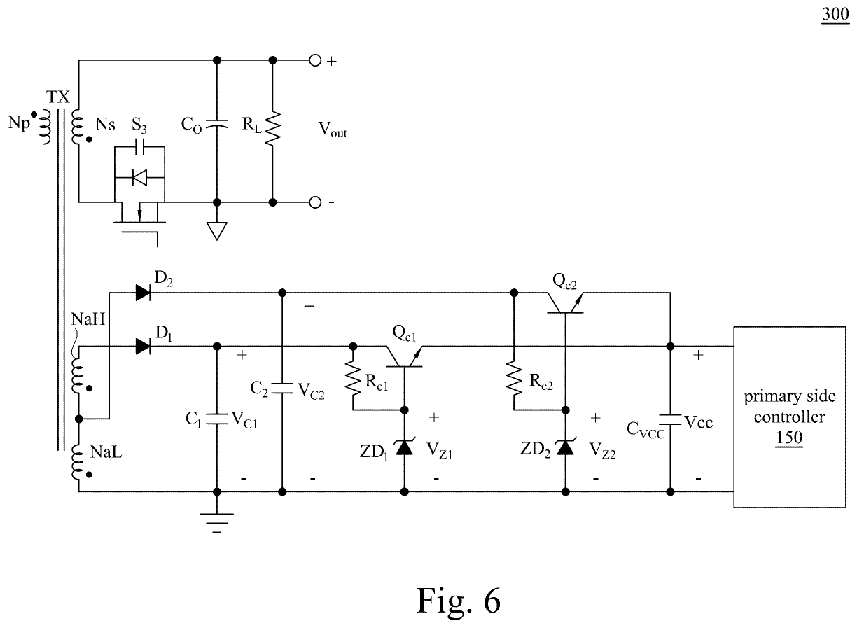

A description is provided with reference to FIG. 6. FIG. 6 depicts a schematic diagram of power supply 600 according to some embodiments of the present disclosure. Compare to FIG. 3 illustrates the power supply 100 including the regulator switches Q₁ and Q₂ implemented by the depletion field effect transistors, the regulator switches Q_{c1} and Q_{c2} included in the power supply 300 in FIG. 6 are implemented by bipolar junction transistors, and the resistors R_{c1} and R_{c2} are disposed accordingly to achieve the same/similar functions with the power supply 100. In some embodiments, the connection relationship and operation manner of the other elements included in the power supply 300 are the same to or similar with the connection relationship and operation manner of the other elements included in the power supply 200, and the description is omitted here.

Summary, the power supplies 100, 200 and 300 of the present disclosure power to the controller by two auxiliary windings cooperated with two voltage regulator circuits, which is able to expand an operating voltage range for supplying power to the controller by the second auxiliary winding and the second voltage regulator circuit, and accordingly reduce an operating voltage range for supplying power to the controller by the first auxiliary winding and the first voltage regulator circuit, in order to reduce and disperse overall loss, and further to lower the specification for selecting components.

Although specific embodiments of the disclosure have been disclosed with reference to the above embodiments, these embodiments are not intended to limit the disclosure. Various alterations and modifications may be performed on the disclosure by those of ordinary skills in the art without departing from the principle and spirit of the disclosure. Thus, the protective scope of the disclosure shall be defined by the appended claims.

What is claimed is:

1. A power supply, comprising:
a first auxiliary winding, with a first end electrically connected to a ground terminal;
a second auxiliary winding, with a first end electrically connected to a second end of the first auxiliary winding;
a first supply circuit, electrically connected between a second end of the second auxiliary winding and a primary side controller, wherein the first supply circuit comprises a first rectifier circuit and a first voltage regulator circuit; and
a second supply circuit, electrically connected between the second end of the first auxiliary winding and the primary side controller, wherein the second supply circuit comprises a second rectifier circuit and a second voltage regulator circuit, wherein:
the first auxiliary winding and the second auxiliary winding power to the primary side controller through the first rectifier circuit and the first voltage regulator circuit of the first supply circuit; or
the first auxiliary winding power to the primary side controller through the second rectifier circuit and the second voltage regulator circuit of the second supply circuit.

2. The power supply of claim 1, wherein the first voltage regulator circuit is electrically connected between the second end of the second auxiliary winding and the primary side controller, wherein when a first input voltage generated by the first auxiliary winding and the second auxiliary winding by inductive coupling exceeds a sum of a first clamp voltage, an negative of a first threshold voltage and a voltage drop across the first rectifier circuit, the first voltage regulator circuit is configured to clamp the first input voltage to a first voltage.

3. The power supply of claim 2, wherein the second voltage regulator circuit is electrically connected between the second end of the first auxiliary winding and the primary side controller, wherein when a second input voltage generated by the first auxiliary winding by inductive coupling exceeds a sum of a second clamp voltage, an negative of a second threshold voltage and a voltage drop across the second rectifier circuit, the second voltage regulator circuit is configured to clamp the second input voltage to a second voltage.

4. The power supply of claim 3, wherein the second voltage is greater than the first voltage.

5. The power supply of claim 3, wherein the second clamp voltage is greater than the first clamp voltage.

6. The power supply of claim 1, wherein the first rectifier circuit comprises:
a first diode, with a first end electrically connected to the second end of the second auxiliary winding, and wherein the power supply further comprises:
a first smoothing capacitor, with a first end electrically connected to a second end of the first diode, with a second end electrically connected to the ground terminal.

7. The power supply of claim 6, wherein the first voltage regulator circuit comprises:
a first regulator switch, with a first end electrically connected to the second end of the first diode, with a second end electrically connected to the primary side controller; and
a first regulator diode, electrically connected between a control end of the first regulator switch and the ground terminal.

8. The power supply of claim 6, wherein the second rectifier circuit comprises:
a second diode, with a first end electrically connected to the second end of the first auxiliary winding, and wherein the power supply further comprises:
a second smoothing capacitor, with a first end electrically connected to a second end of the second diode, with a second end electrically connected to the ground terminal.

9. The power supply of claim 8, wherein the second voltage regulator circuit comprises:
a second regulator switch, with a first end electrically connected to the second end of the second diode, with a second end electrically connected to the primary side controller; and
a second regulator diode, electrically connected between a control end of the second regulator switch and the ground terminal.

10. The power supply of claim 8, wherein:
when a voltage output by the first supply circuit is greater than a voltage output by the second supply circuit, the second supply circuit is turned off; and
when the voltage output by the first supply circuit is less than the voltage output by the second supply circuit, the first supply circuit is turned off.

11. The power supply of claim 1, wherein the number of turns of the first auxiliary winding is more than the number of turns of the second auxiliary winding.

12. The power supply of claim 1, wherein the number of turns of the first auxiliary winding is 9, and wherein the number of turns of the second auxiliary winding is 4.

13. A power supply, comprising:
a first auxiliary winding, with a first end electrically connected to a ground terminal;
a second auxiliary winding, with a first end electrically connected to a second end of the first auxiliary winding;
a first rectifier circuit;
a first voltage regulator circuit, comprising a first regulator switch and a first regulator diode electrically connected between a control end of the first regulator switch and the ground terminal, and wherein the first rectifier circuit and the first regulator switch are electrically connected in series between a second end of the second auxiliary winding and a primary side controller;
a second rectifier circuit; and
a second voltage regulator circuit, comprising a second regulator switch and a second regulator diode electrically connected between a control end of the second regulator switch and the ground terminal, wherein the second rectifier circuit and the second regulator switch are electrically connected between the second end of the first auxiliary winding and the primary side controller, wherein a first clamp voltage of the first regulator diode is less than a second clamp voltage of the second regulator diode.

14. The power supply of claim 13, wherein the number of turns of the first auxiliary winding is more than the number of turns of the second auxiliary winding.

15. The power supply of claim 13, wherein the number of turns of the first auxiliary winding is 9, and wherein the number of turns of the second auxiliary winding is 4.
